(19) United States
(12) Patent Application Publication
(10) Pub. No.: US 2017/0302384 A1
(43) Pub. Date: Oct. 19, 2017

(54) OPTICAL TRANSMISSION SYSTEM, TRANSMISSION APPARATUS, AND METHOD OF CONTROLLING WAVELENGTH

(71) Applicant: FUJITSU LIMITED, Kawasaki-shi (JP)

(72) Inventor: TSUTOMU TSURUMI, Kawasaki (JP)

(73) Assignee: FUJITSU LIMITED, Kawasaki-shi (JP)

(21) Appl. No.: 15/473,717

(22) Filed: Mar. 30, 2017

(30) Foreign Application Priority Data
Apr. 19, 2016 (JP) 2016-084051

(51) Int. Cl. H04B 10/572; H04B 10/61; H04B 10/079

(52) U.S. Cl. CPC H04B 10/572; H04B 10/07953; H04B 10/616

(57) ABSTRACT

A first transmission apparatus includes a first transmitter and a first receiver. The first transmission apparatus transmits a first optical signal to a second transmission apparatus, which is generated by modulating first light output by a first light source. The first receiver coherently receives a second optical signal transmitted by a second transmission apparatus using the first light output by the first light source. The second transmission apparatus includes a second transmitter, a second receiver, and a controller. The second transmitter transmits the second optical signal to the first transmission apparatus, which is generated by modulating second light output by a second light source. The second receiver coherently receives the first optical signal transmitted by the first transmission apparatus using the second light output by the second light source. The controller controls a wavelength of the second light to be output by the second light source.

### CROSS-REFERENCE TO RELATED APPLICATIONS

This application is based upon and claims the benefit of priority of the prior Japanese Patent Application No. 2016-84051, filed on Apr. 19, 2016, the entire contents of which are incorporated herein by reference.

### FIELD

The embodiments discussed herein are related to an optical transmission system, a transmission apparatus, and a method of controlling a wavelength.

### BACKGROUND

Optical transmission systems utilizing optical signals have been in practice use as large-capacity information transmission systems. Additionally, coherent optical transmission techniques have been employed to further increase transmission capacities of optical transmission systems, for example. Such a coherent optical transmission is carried out bidirectionally between transmission apparatuses through a network line. Specifically, each transmission apparatus transmits and receives light through the network line.

A transmission apparatus is provided with an optical transceiver (light module) that has light transmission and reception functions, and multiple transmission apparatuses are connected to a network line. Each of the optical transceivers provided in the multiple transmission apparatuses includes a transmitter that transmits light and a receiver that receives light.

In coherent optical transmission techniques, a receiver carries out a coherent reception of light using light generated (oscillated) by a local oscillation light source, to extract intensity information and phase information of optical signals received from the network line.
Patent Document 1: International Publication Pamphlet No. WO 2012/153856
Patent Document 2: Japanese Laid-open Patent Publication No. 03-290630

In such coherent optical transmission techniques, respective light sources are provided in both a transmitter and a receiver since a light source is also used in the receiver provided in an optical transceiver. Hence, an optical transceiver having a transmitter and a receiver integrated therein have two light sources: one for transmitting light and another for a local oscillation. As a result, it is difficult to achieve a size reduction of an optical transceiver in an optical transmission system that carries out coherent light transmissions, and also the manufacturing costs are increased. Furthermore, another issue of increased the power consumption is also incurred.

### SUMMARY

In one aspect, an optical transmission system includes a first transmission apparatus and a second transmission apparatus connected to the first transmission apparatus so as to be optically communicative to each other. The first transmission apparatus includes a first light source, a first transmitter, and a first receiver. The second transmission apparatus includes a second light source, a second transmitter, a second receiver, and a controller. The first transmitter is configured to transmit a first optical signal to the second transmission apparatus, the first optical signal being generated by modulating first light output by the first light source. The first receiver is configured to coherently receive a second optical signal transmitted by the second transmission apparatus, using the first light output by the first light source. The second transmitter is configured to transmit the second optical signal to the first transmission apparatus, the second optical signal being generated by modulating second light output by the second light source. The second receiver is configured to coherently receive the first optical signal received by the first transmission apparatus, using the second light output by the second light source. The controller is configured to control a wavelength of the second light to be output by the second light source, based on a result of the reception of the first optical signal by the second receiver.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an overview diagram of an optical transmission system having a transmission apparatus in accordance with a first embodiment;

FIG. 2 is a functional block diagram of a node having a transmission apparatus in accordance with the first embodiment;

FIG. 3 is a functional block diagram of a transponder (TRSP) in accordance with the first embodiment;

FIG. 4 is a diagram depicting one example of an optical transmission system including the TRSP in accordance with the first embodiment;

FIG. 5 is a functional block diagram of the optical transmission system including the TRSP in accordance with the first embodiment;

FIGS. 6A and 6B are diagram depicting relationships between wavelengths of optical signals that are input and output in an optical transmission system;

FIG. 7 is a flowchart of processing of controlling a wavelength of a light source in the optical transmission system having the transmission apparatus in accordance with the first embodiment;

FIG. 8 is a flowchart of processing of controlling a wavelength of the light source in the optical transmission system having the transmission apparatus in accordance with the first embodiment;

FIG. 9 is a flowchart of processing of controlling a wavelength of a light source in an optical transmission system having a transmission apparatus in accordance with a second embodiment;

FIGS. 10A-10J are diagrams illustrating examples where the processing depicted in the flowchart in FIG. 9 is executed;

FIGS. 11A and 11B are diagram depicting examples of a spectrum of light output by a light source and a spectrum of received optical signal when the resolution of the wavelength is changed;

FIG. 12 is a functional block diagram of an optical transmission system having a transmission apparatus in accordance with a first modification;

FIG. 13 is a functional block diagram of an optical transmission system having a transmission apparatus in accordance with a second modification;

FIG. 14 is a functional block diagram of an optical transmission system having a transmission apparatus in accordance with a third modification; and

FIG. 15 is a functional block diagram of an optical transmission system having a transmission apparatus in accordance with a comparative example.

### DESCRIPTION OF EMBODIMENT(S)

Hereinafter, embodiments will be described with reference to the drawings. Note that the embodiments discussed below are merely exemplary, and it is not intended to exclude various modifications to and applications of the techniques. In the drawings used in descriptions of the embodiments, elements referenced to by like reference symbols denote the same or similar elements unless otherwise stated. Furthermore, when a plurality of the same or similar elements are illustrated in the drawings, they are distinguished using “#k” (k is a natural number).

### First Embodiment

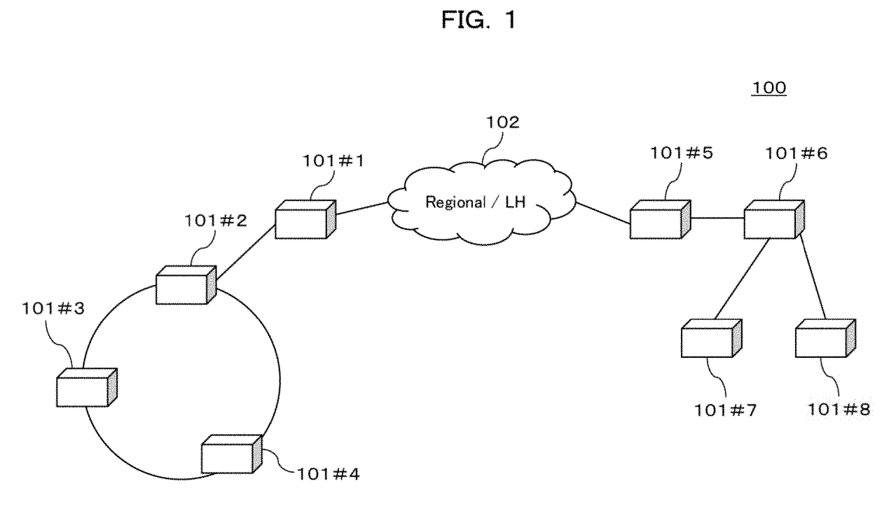

FIG. 1 is an overview diagram of an optical transmission system 100 having nodes 101 #1-#8. As will be described later, each node 101 includes a transmission apparatus in accordance with a first embodiment. In the optical transmission system 100, the nodes 101 #1-#8 are connect to a regional network 102 that is one example of a long-haul light network, in a wide variety of various topologies. For example, the node 101 #1-#4 and the nodes 101 #5-#8 form respective optical core networks. The nodes 101 #2-#4 are connected in a ring configuration, and the node 101 #2 is connected to the regional network 102 via the node 101 #1. The node 101 #6-#8 are connected in a tree configuration, and the node 101 #6 at the root of the tree is connected to the regional network 102 via the node 101 #5.

The optical transmission system 100 depicted in FIG. 1 allows various devices to be connected to the nodes 101 #1-#8, thereby enabling optical communications between the devices.

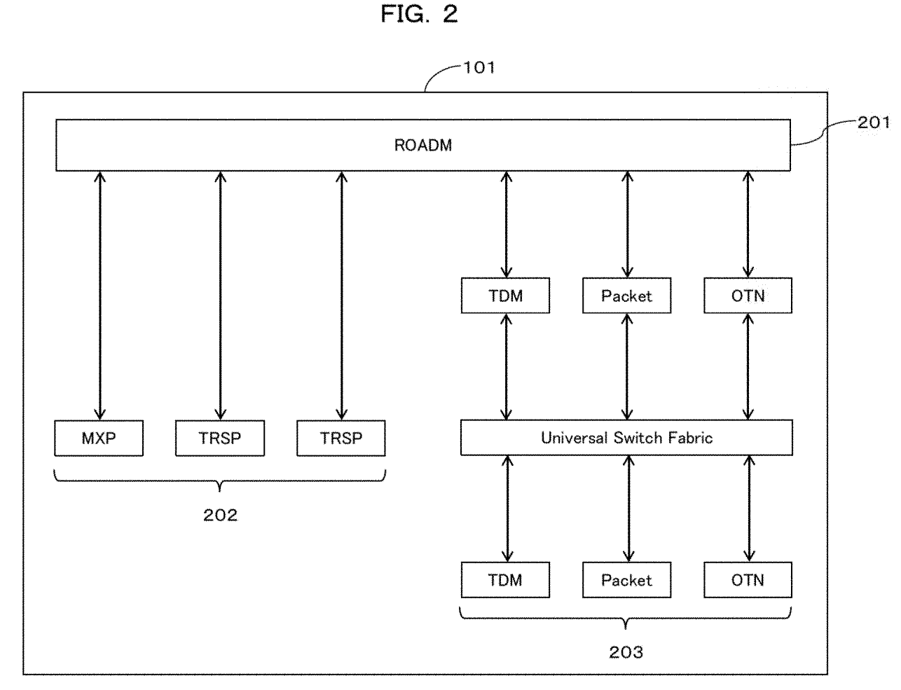

FIG. 2 is a functional block diagram of a node 101. In FIG. 2, the node 101 includes a ROADM 201, a first input and output unit 202, and a second input and output unit 203.

ROADM is an abbreviation for Reconfigurable Optical Add/Drop Multiplexer. The ROADM 201 can receive optical signals by splitting the optical signals from an upper-level network side, e.g., an optical core network, and add optical signals to the upper-level network side by transmitting the optical signals to the upper-level network side.

The first input and output unit 202 includes transmission apparatuses that function as a muxponder (MXP), a transponder (TRSP), and the like. In the second input and output unit 203, apparatuses having interface functions with TDMs, Packets, OTNs, and the like, are connected to the ROADM via a Universal Switch Fabric. Therefore, using the second input and output unit 203, communications among the TDMs, the Packets, and the OTNs are achieved, without limiting to any of the TDMs, the Packets, and the OTNs. Note that TDM is an abbreviation for Time Division Multiplexer, and OTN is an abbreviation for Optical Transport Network.

Hence, the first input and output unit 202 and the second input and output unit 203 enable optical signals to be branched and received from the upper-level network side, and to be transmitted to the upper-level network via the ROADM 201.

Note that the MXP and the TRSP in the first input and output unit 202 and the TDMs, the Packets, the OTNs, and the Universal Switch Fabric in the second input and output unit 203 may be provided in the form of cards that can be inserted to a casing. In other words, the functions of the MXP, the TRSP, the TDMs, the Packets, the OTNs, and the Universal Switch Fabric may be provided as modules to configure the casing of the node 101, and modules may assume the forms of cards.

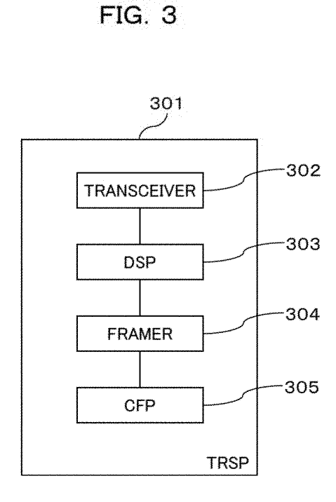

Here, a TRSP as one example of a transmission apparatus will be described. FIG. 3 is a functional block diagram of a TRSP 301. The TRSP 301 includes a transceiver 302, a DSP 303, a framer 304, and a CFP 305. DSP is an abbreviation for Digital Signal Processor, and CFP is an abbreviation for Centum Gigabit Form Factor Pluggable.

The CFP 305 is one example of a transceiver. The transceiver is an interface that inputs and outputs data transmitted and received via the transceiver 302. An optical signal received from an outside of the TRSP 301 is converted into an electric signal through the transceiver 302, the DSP 303, and the framer 304, and is output to a device to be connected to the CFP 305. An electric signal input from the device to be connected to the CFP 305 is ultimately converted into an optical signal through the framer 304, the DSP 303, and the transceiver 302, and the resultant optical signal is output to an outside of the TRSP 301.

The framer 304 carries out a conversion between data of an electric signal (e.g., analog electric signal) that is input and output through the CFP 305 and digital data in a frame format. In other words, the framer 304 demodulates a signal output from the DSP 303 into digital data in a frame format, and outputs the demodulated signal to the CFP 305. The framer 304 also convert an electric signal output by the CFP 305 into digital data in a frame format, and outputs the converted digital data to the DSP 303.

The DSP 303 is processor that processes digital signals. The DSP 303 multiplexes digital signals in frame formats output by the framer 304, and outputs the multiplex signal to the transceiver 302. The DSP 303 also converts an optical signal received by the transceiver 302 into a digital signal, and outputs the resultant signal that has undergone the digital signal processing to the framer 304. The DSP 303 may include a processor and a memory for executing a program. By executing the program, the processor eliminates undesirable effects on an optical signal, such as a distortion of the waveform, which may be induced while the optical signal is being propagated through an optical transmission path. Alternatively, the DSP 303 may include hardware instead using a program.

The transceiver 302 modulates an optical signal with a multiplexed signal output by the DSP 303, and transmits the modulated optical signal. The transceiver 302 also converts a coherently received optical signal to an electric signal, and outputs the converted electric signal to the DSP 303.

The transceiver 302 transmits and receives optical signals, and hence may be referred to as the “optical transceiver”.

Note that the transmission apparatus as one example of the TRSP 301 may include the transceiver 302, the DSP 303, the framer 304, and the CFP 305, as modules. For example, the transceiver 302 may be provided as an optical transmission and reception module that can be inserted to the TRSP 301.

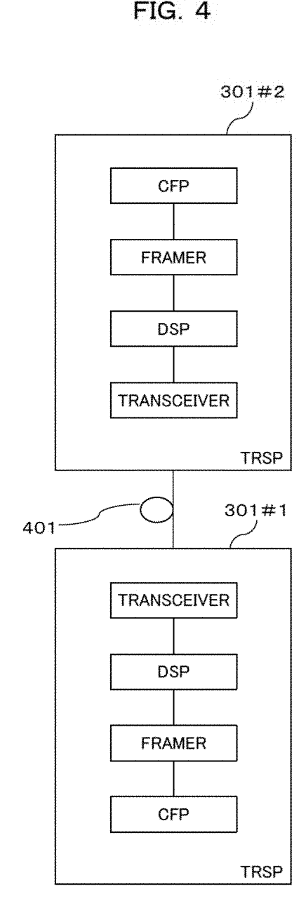

FIG. 4 is one example of an optical transmission system that carries out optical communications between multiple points. In other words, optical communications can be achieved by locating TRSPs 301 #1 and 301 #2 at two points among the multiple points and by connecting them through an optical transmission path. As depicted in FIG. 4, the TRSP 301 #1 and the TRSP 301 #2 located at the two points are connected between the opposing ends, having the optical transmission path 401 interposed therebetween. Furthermore, an optical relay may be disposed between the TRSP 301 #1 and the TRSP 301, or the TRSP 301 #1 and the TRSP 301 #2 may be provided at respective nodes, in FIG. 4.

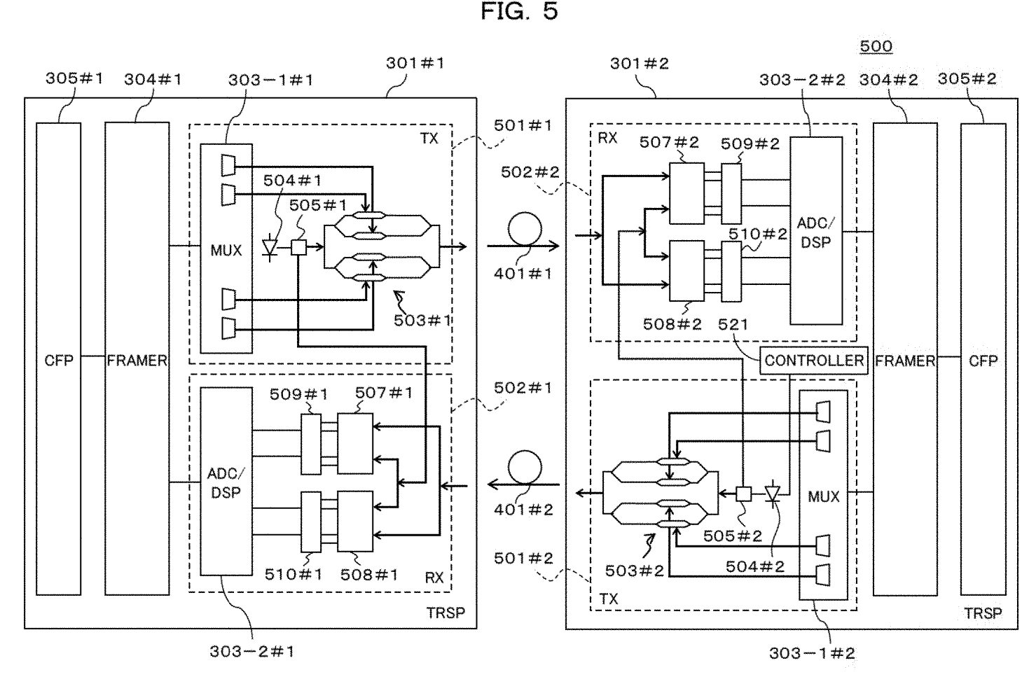

FIG. 5 is a detailed functional block diagram of an optical transmission system 500 where the TRSP 301 #1 and the TRSP 301 #2 are connected between the opposing ends, as depicted in FIG. 4.

The TRSP 301 #1 includes a transmitter 501 #1 and a receiver 502 #1. The transmitter 501 #1 and the receiver 502 #1 are equivalent to the transceiver 302 (optical transceiver) in the TRSP 301 depicted in FIG. 3. The TRSP 301 #2 includes a transmitter 501 #2 and a receiver 502 #2. The transmitter 501 #2 and the receiver 502 #2 are equivalent to the transceiver 302 in the other TRSP 301 depicted in FIG. 3. Note that the TRSP 301 having the transceiver 302 equivalent to the transmitter 501 #1 and the receiver 502 #1 is different from the TRSP 301 having the transceiver 302 equivalent to the transmitter 501 #2 and the receiver 502 #2.

The transmitter 501 #1 and the receiver 502 #2 are connected through an optical transmission path 401 #1, and the transmitter 501 #2 and the receiver 502 #1 are connected through an optical transmission path 401 #2. The optical transmission paths 401 #1 and 401 #2 may be separate optical transmission paths as depicted in FIG. 5, or may be a single optical transmission path that propagates optical signals bidirectionally, as the optical transmission path 401 depicted in FIG. 4.

The TRSP 301 #2 is also provided with a controller 521. The controller 521 controls the wavelength of light generated and output by the light source 504 #2. While the controller 521 is provided with the TRSP 301 #2 as depicted in FIG. 5, no controller 521 may be provided with the TRSP 301 #1. Alternatively, the TRSP 301 #1 may also be provided with a controller 521.

When the TRSP 301 #1 and the TRSP 302 #2 are provided with respective controllers 521, it is preferred that one of the controllers 521 operates upon an operation of the optical transmission system 500. For example, the controller 521 in the TRSP 301 #1 or the TRSP 301 #2 that is powered on first may operate, and the other controller 521 in the TRSP 301 #1 or #2 that is powered on later may not operate. Alternatively, the TRSP 301 #1 and the TRSP 301 #2 may store respective numbers, e.g., manufacturing serial numbers. The TRSP 301 #1 and the TRSP 301 #2 exchange their manufacturing serial numbers, and the controller 521 in the TRSP 301 having the greater manufacturing serial number may operate and the other controller 521 in the TRSP 301 with the smaller manufacturing serial may not operate, for example. The decision as to which of the controllers 521 may be operated may be made by a selection controller (not illustrated), for example.

In FIG. 5, the receiver 502 #1 and the receiver 502 #2 have the same configurations, and the transmitter 501 #1 and the transmitter 501 #2 have substantially the same configurations. Hence, hereinafter, when referring to elements in the transmitter 501 #1 and elements in the transmitter 501 #2, they may be distinguished by #k (k=1 or 2), and for other elements, #k may be omitted.

The transmitter 501 includes a MUX 303-1, a modulator 503, a light source 504, and an optical branch unit 505.

The MUX 303-1 multiplexes digital signals in frame formats input from the framer 304, and outputs the resultant signal to the modulator 503. Note that the MUX 303-1 may be a part of the DSP 303.

The light source 504 outputs (generates) light. Alternatively, it may be referred to that the light source 504 “oscillates light”, and the wavelength of output light may be referred to as the “oscillation wavelength”. The light output by the light source 504 is output to an optical branch unit 505. The light output by the light source 504 is coherent light, and one example of coherent light includes laser light. One example of the light source 504 includes a laser diode.

Of the light sources 504 #1 and 504 #2, the wavelength (or frequency) of light output by the light source 504 #1 may be fixed. In contrast, of the light sources 504 #1 and 504 #2, the wavelength of light output by the light source 504 #2 is variable under the control of the controller 521. For example, a wavelength can be selected from multiple light wavelengths, and the controller 521 may control the light source 504 #2 to output light at the selected wavelength. The controller 521 also changes (adjusts) the wavelength of light to be output by the light source 504 #2 to a wavelength in the vicinity of the selected wavelength.

The optical branch unit 505 branches light output by the light source 504 into light beams, and outputs one of them to the modulator 503 and the other to the receiver 502. The light branching ratio by the optical branch unit 505 may be set to an appropriate ratio, e.g., 1:1, for example. One example of the optical branch unit 505 may include a splitter (or coupler).

Accordingly, light at the same wavelength is output from the optical branch unit 505 to the modulator 503 and to the receiver 502.

Note that the light source 504 is disposed within the transmitter 501 in FIG. 5. In other words, the light source 504 is integrated into the transmitter 501. This helps to reduce the number of elements used for optical communications, and to facilitate the connections among the elements. The light source 504 is not limited to being dispose inside the transmitter 501. For example, the light source 504 may be disposed within the receiver 502, as will be described later.

Hence, it can be regarded that the transceiver 302 (optical transceiver) includes the light source 504, the transmitter 501, and the receiver 502.

Alternatively, the light source 504 may be disposed outside the TRSP 301, and the light source 504 and the optical branch unit 505 may be connected through a waveguide. Disposing the light source 504 outside the TRSP 301 in this manner helps to reduce the size of the TRSP 301.

The modulator 503 modulates light output from the optical branch unit 505 according to an output signal from the MUX 303-1, and outputs the modulated optical signal. Hence, one of the light beams branched by the optical branch unit 505 is modulated into an optical signal. The modulator 503 depicted in FIG. 5 includes four elements, and light from the optical branch unit 505 is supplied to each of the elements. The elements of the modulator 503 may be Mach-Zehnder modulators, for example.

When the modulator 503 depicted in FIG. 5 includes the four elements, it is possible to carry out polarized wave multiplexing. In other words, XI and XQ of an X-polarized wave signal XI+jXQ (j is an imaginary unit) are output to two of the four elements, and YI and YQ of a Y-polarized wave signal YI+jYQ are output to the rest of the elements.

Note that the modulation scheme employed by the modulator 503 is not limited to the polarized wave multiplexing scheme, as long as coherent optical transmissions are available by the receiver 502 in the opposing TRSP 301. Therefore, the number of elements in the modulator 503 may be suitably selected according to the modulation schemes.

When polarized wave multiplexing is carried out, output light from the elements in the modulator 503 is multiplexed with an optical signal corresponding to the X-polarized wave signal XI+jXQ to generate X-polarized wave light corresponding to the X-polarized wave signal. Further, the optical signal corresponding to the Y-polarized wave signal YI+jYQ is multiplexed to generate Y-polarized wave light corresponding to the Y-polarized wave signal. The X-polarized wave light and the Y-polarized wave light are input into a polarization beam combiner, to form a polarized wave multiplexed optical signal from the X-polarized wave light and the Y-polarized wave light, and the resultant optical signal is output from the modulator 503 to the optical transmission path 401.

The receiver 502 includes 90-degree optical hybrid circuits 507 and 508, amplifiers 509 and 510, and an analog digital convertor (ADC)/DSP 303-2.

The light propagated from the optical transmission path 401 is input into a first polarization beam splitter, and a pair of polarized wave light beams that are orthogonal to each other are input to the 90-degree optical hybrid circuits 507 and 508, respectively, from the first polarization beam splitter. In other words, polarized wave light modulated with the X-polarized wave signal is input into one of the 90-degree optical hybrid circuits 507 and 508, and polarized wave light modulated with the Y-polarized wave signal is input to the other of the 90-degree optical hybrid circuits 507 and 508.

Further, the other light beam branched by the optical branch unit 505 is guided to the receiver 502 and is split by a second polarization beam splitter into a pair of polarized wave light beams that are orthogonal to each other, which are guided into the 90-degree optical hybrid circuits 507 and 508, respectively. One of the light beams split by the second polarization beam splitter is guided to the 90-degree optical hybrid circuit 507, and the other is guided to the 90-degree optical hybrid circuit 508.

To the 90-degree optical hybrid circuit 507, one of the outputs from the first polarization beam splitter and one of the outputs from the second polarization beam splitter are input. As a result, an electric signal corresponding to I component light (corresponding to the XI optical signal) and Q component light (corresponding to the XQ optical signal) corresponding to the X-polarized wave signal are output from the 90-degree optical hybrid circuit 507. Further, to the 90-degree optical hybrid circuit 508, the other of the outputs from the first polarization beam splitter and the other of the outputs from the second polarization beam splitter are input, and I component light and Q component light corresponding to the Y-polarized wave signal are output. Therefore, the light source 504 in the transmitter 501 also functions as a local oscillation light source for the receiver 502. In other words, the light guided to the receiver 502 by the optical branch unit 505, of the light output by the light source 504 in the transmitter 501, can be used as light of the local oscillation light source for coherent receptions.

The electric signals output by the 90-degree optical hybrid circuits 507 and 508 are input into and amplified by the amplifiers 509 and 510, respectively.

The electric signals amplified by the amplifiers 509 and 510 are input into the ADC/DSP 303-2, are converted into a digital signal through digital signal processing, and are output to the framer 304. The digital signal processing involves processing for a compensation of a waveform distortion and compensation of a wavelength dispersion, which may be induced along the optical transmission path 401, for example. Note that the ADC/DSP 303-2 may be provided as a part of the DSP 303.

As set forth above, the light at the same wavelength is input from the optical branch unit 505 #1, to the modulator 503 #1 in the transmitter 501 #1 and the 90-degree optical hybrid circuits 507 and 508 in the receiver 502 #1. Further, the light at the same wavelength is input from the optical branch unit 505 #2, to the modulator 503 #2 in the transmitter 501 #2 and the 90-degree optical hybrid circuits 507 and 508 in the receiver 502 #2.

In accordance with the aforementioned configuration, a single light source 504 is disposed for a transmitter 501 and a receiver 502, and hence it is possible to reduce the number of light sources provided in a TRSP 301 to one by sharing that light source 504 between the transmitter 501 and the receiver 502. Therefore, it is possible to reduce the space of additional light source that is used in the TRSP 301, and to reduce the size of the TRSP 301. Further, the reduction of the light source into one also contributes to a reduction in the manufacturing costs of transmission apparatuses, as well as a reduction in the power consumption during operations of the transmission apparatuses.

Note that the wavelength of light output from the optical branch unit 505 #1 to the modulator 503 #1 does not always matches the central wavelength (carrier wave wavelength) of an optical signal received by the 90-degree optical hybrid circuits 507 #1 and 508 #1 from the optical transmission path 401 #2. Further, the wavelength of light output from the optical branch unit 505 #2 to the modulator 503 #2 does not always matches the central wavelength of light received by the 90-degree optical hybrid circuits 507 #2 and 508 #2 from the optical transmission path 401 #1. Hence, the wavelengths of light output by at least one of the light source 504 #1 and the light source 504 #2 are to be controlled (adjusted).

Hereinafter, an example to adjust one of the wavelengths of output light from the light source 504 #1 and the light source 504 #2 will be described. In the above configuration, therefore, it is possible to readily adjust the wavelength of output light from the light source 504.

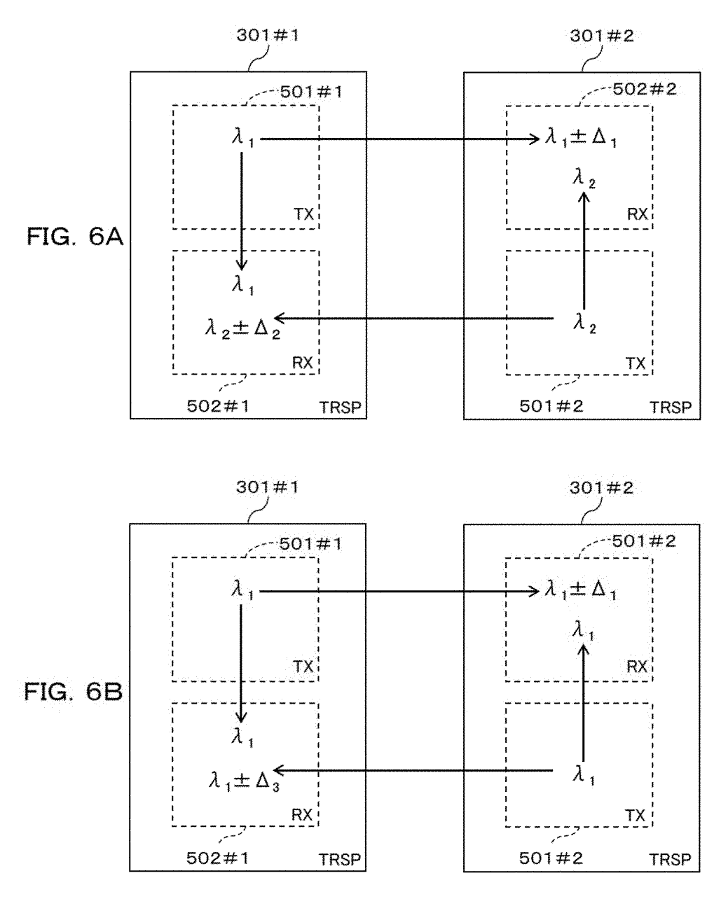

FIGS. 6A and 6B are diagrams depicting relationships between light that is input and output in the optical transmission system 500.

Referring to FIG. 6A, it is assumed that light with a wavelength of λ₁ is output by the light source 504 #1 in the transmitter 501 #1. The receiver 502 #2 will receive an optical signal having a carrier wave wavelength of λ₁ at the center and a divergence of ±Δ₁ due to the modulation by the modulator 503 #1 and wavelength dispersion along the optical transmission path 401 #1. Similarly, when light with a wavelength of λ₂ is output by the light source 504 #2 in the transmitter 501 #2, the receiver 502 #1 will receive an optical signal having a carrier wave wavelength of λ₂ at the center and a divergence of ±Δ₂.

Further, light with a wavelength of λ₁ will be output by the light source 504 #1 in the transmitter 501 #1 to the receiver 502 #1, and light with a wavelength of λ₂ will be output by the light source 504 #2 in the transmitter 501 #2 to the receiver 502 #2.

The reception quality of the coherent reception at the receiver 502 is reduced as the difference between λ₁ and λ₂ increases. The reduction in the reception quality is detected as a reduction in electric currents output by the amplifiers 509 and 510, and as an increase in the error rate of a demodulate signal at the framer 304. It means that the amplifiers 509 and 510 can be used as detectors of the reception qualities. The framer 304 can also be used as another detector of the reception qualities. An interferometer that measures how much the frequency of light received by the receiver 502 #2 is close to the frequency of light branched by the optical branch unit 505 #2 may also be used as a further detector.

When λ₂ is adjusted to be equal to λ₁ by the controller 521, as depicted in FIG. 6B, the receiver 502 #2 will receive an optical signal having λ₁ at the center and having a divergence of ±Δ₁, and an optical signal having a wavelength of λ₁ will be input from the optical branch unit 505 #2. In other words, the carrier wave wavelength of an optical signal received by the 90-degree optical hybrid circuits 507 and 508 will match the wavelength of light received from the optical branch unit 505 #2. As a result, the reception quality will be increased at the receiver 502 #2. Similarly, an optical signal having a carrier wave wavelength of λ₁ at the center and having a divergence of ±Δ₃ will also be received at the receiver 502 #1, and light having a wavelength of λ₁ will be input from the optical branch unit 505 #1. As a result, the reception quality will also be increased at the receiver 502 #1.

In other words, it is possible to further increase the reception quality at the receiver 502 #1, by controlling by the controller 521 to increase the wavelength of the light source 504 #2 such that the reception quality at the receiver 502 #2 is further increased. In other words, both a control on the reception quality at the receiver 301 #1 and a control on the reception quality at the receiver 301 #2 can also be achieved by controlling the wavelength of the light source 504 #2.

Hereinafter, processing of controlling the wavelength of the light source 504 #2 by the controller 521 will be described.

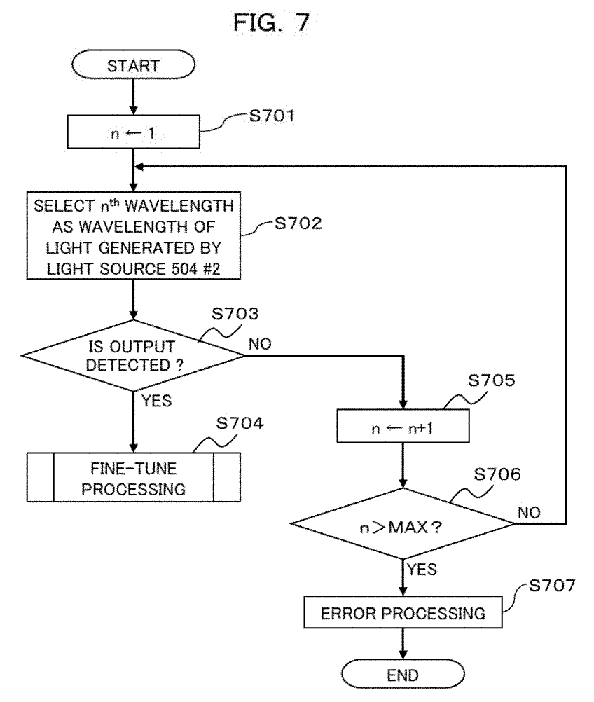

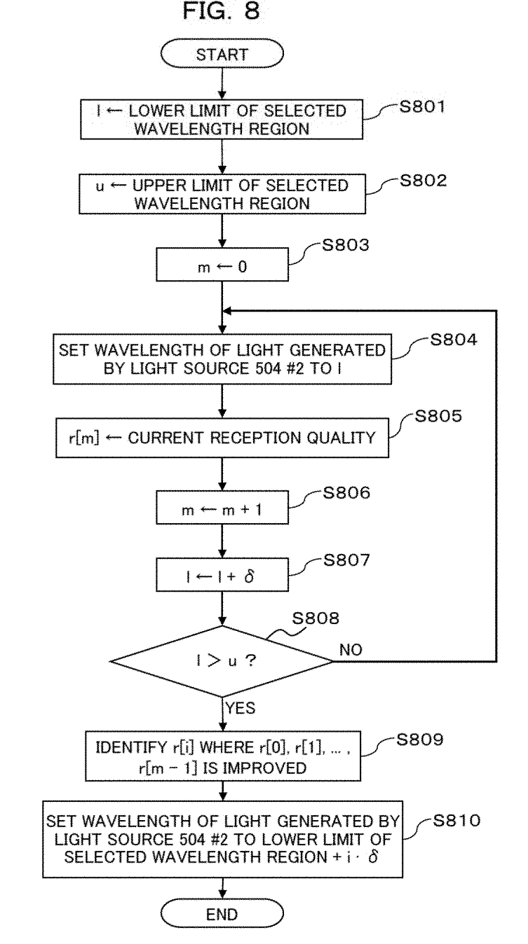

FIG. 7 is a flowchart of processing by the controller 521 when a wavelength of light to be output by the light source 504 #2 is selectable from multiple wavelengths. In other words, FIG. 7 is a flowchart for determining which wavelength is to be selected when a wavelength of light to be output by the light source 504 #2 is selectable from multiple wavelengths in an increment of 20 nm, for example. When there is no need to select the wavelength of light to be output by the light source 504 #2, the processing in FIG. 8 is carried out without carrying out the processing in FIG. 7.

The processing in FIG. 7 is carried out when light is output by the light sources 504 #1 and 504 #2, and optical signals are output from the transmitters 501 #1 and 501 #2 to the optical transmission paths 401 #1 and 401 #2, respectively.

In the processing in Step S701, the variable “n” is initialized to 1. The variable “n” represents the number of the wavelength selected. In the processing in Step S702, the n^{th} wavelength is selected as the wavelength of light to be output from the light source 504 #2. In Step S703, it is determined whether an output is detected or not. The term “an output is detected” means that the electric current value of an electric signal output by at least one of the amplifiers 509 #2 and 510 #2 is not zero. Or, the term “an output is detected” means that the result of a demodulation by the framer 304 #2 is satisfactory (e.g., the error rate is less than 3%).

When an output is detected in Step S703, the processing braches to the YES route and fine tune processing is carried out at the n^{th} wavelength in the processing in Step S704. The fine tune processing is processing of a flowchart depicted in FIG. 8, which will be described later.

When no output is detected in Step S703, the processing braches to the NO route and the value of the variable “n” is incremented by one in the processing in Step S705. In Step S706, it is determined whether or not the value of “n” exceeds a given number MAX. MAX may represent the number of wavelengths selectable as the wavelength of light to be output by the light source 504 #2.

When “n” exceeds the MAX in Step S706, the processing braches to the YES route and error processing is executed in the processing in Step S707. For example, an error is displayed on a display device provided in the TRSP 301 #2.

When “n” does not exceed the MAX in Step S706, the processing braches to the NO route and returns to Step S702.

Next, a reference will be made to FIG. 8. The flowchart in FIG. 8 is executed when the wavelength of light to be output by the light source 504 #1 is the same as or is close to the wavelength of light to be output by the light source 504 #2. In other words, the electric current value of an electric signal output by at least one of the amplifiers 509 #2 and 510 #2 was not zero, or the result of a demodulation by the framer 304 #2 was satisfactory.

FIG. 8 depicts processing wherein the adjustable oscillation wavelength range of the light source 504 #2 is scanned from its lower limit to the upper limit in a given increment 5, reception qualities are measured and recorded in a memory or the like, such that light at a wavelength wherein the highest reception quality has been detected is to be output by the light source 504 #2.

In the processing in Step S801, the lower limit wavelength of selected adjustable wavelengths is assigned to a variable “l”. In Step S802, the upper limit wavelength of the selected adjustable wavelengths is assigned to a variable “u”. Further, in Step S803, zero is assigned to a variable “m”. The variable “m” represents how many wavelengths have been selected so far, as a wavelength to be output by the light source 504 #2. Note that a wavelength region not less than the lower limit wavelength and not greater than the upper limit wavelength of the selected adjustable wavelengths may also be referred to as the “selected wavelength region”.

In the processing in Step S804, the oscillation wavelength of the light source 504 #2 is set to the wavelength represented by the value of the variable “l”.

In the processing in Step S805, the current reception quality is assigned to an element r[m] in an array r to record the value. The current reception quality is the value of the reception quality represented by either or both of the electric current values output by the amplifiers 509 #2 and 510 #2, or the error rate of a demodulation by the framer 304 #2. When both of the electric current values output by the amplifiers 509 #2 and 510 #2 are used, the average, minimum, or maximum of the two electric current values may be calculated, and the resultant value may be assigned to the element r[m].

In the processing in Step S806, the value of the variable “m” is incremented by one. In the processing in Step S807, the value of the variable “l” is increment by δ.

In the processing in Step S808, it is determined whether or not the value of the variable “l” exceeds the value of the variable “u”.

When the value of the variable “l” does not exceed the value of the variable “u” in the processing in Step S808, the upper limit of the adjustable wave lengths is not exceeded. Hence, the processing braches to the NO route, and the processing in Step S804 is carried out again.

When the value of the variable “l” exceeds the value of the variable “u” in the processing in Step S808, the entirety of the adjustable wavelength range has been scanned. Hence, the processing braches to the YES route, and the processing in Step S809 is carried out.

In the processing in Step S809, r[i] in the array r containing the value representing the highest reception quality is identified from the elements r[0], r[1], . . . , and r[m−1]. For example, r[i] containing the highest value may be identified from the reception qualities represented by the values in r[0], r[1], . . . , and r[m−1]. When an electric current value is used as the reception quality, the element in the array r containing the highest electric current value may be identified. When the error rate of digital demodulation is used as the reception quality, the element in the array r containing the smallest error rate may be identified.

In the processing in Step S810, the oscillation wavelength of the light source 504 #2 is set to the wavelength of the sum of the lower limit wavelength of selected wavelength region and (i·δ) (the product of i and δ).

As described above, in the present embodiment, it is possible to adjust the wavelength of the light source 504 #2 provided in the transmitter 501 #2, of the transmitters 501 #1 and 501 #2. As a result, it is possible to match the output wavelengths of the two light sources 504 #1 and 504 #2 provided at the respective transmitters 501 #1 and 501 #2. Further, when a wavelength is selectable from multiple wavelengths, an effective and adjustment selection of a wavelength are made possible by selecting an arbitrary wavelength, scanning across the selected wavelength range, and making slight adjustments. Furthermore, since each of the light sources 504 #1 and 504 #2 is used in the transmitters 501 #1 and 501 #2, respectively, as a local oscillation light source and a light source of light to be transmitted, the number of light sources employed can be reduced.

### Second Embodiment

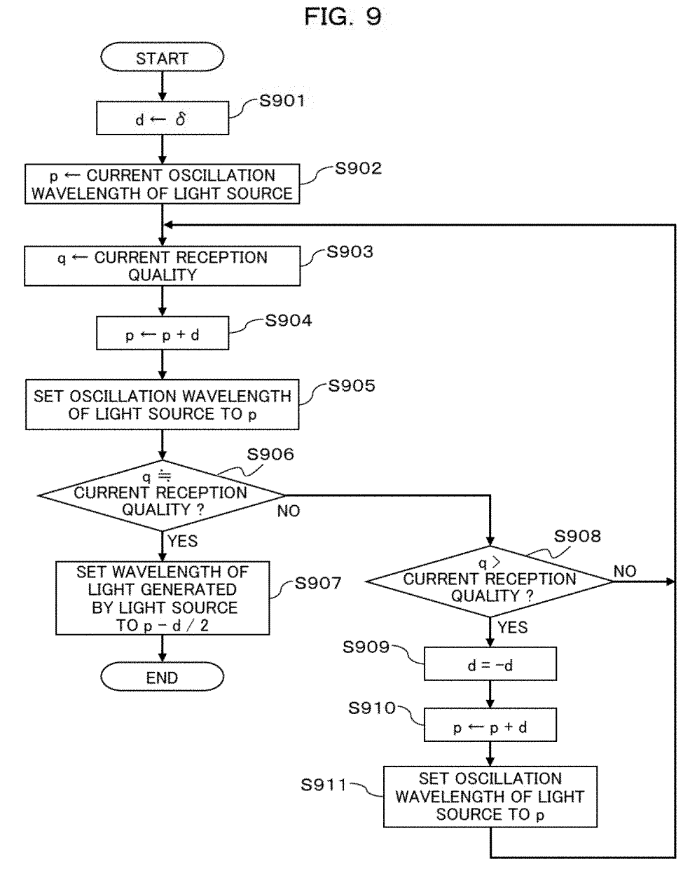

In the processing in FIG. 8 described the first embodiment, a wavelength that provides the highest reception quality is searched for by scanning across a selected wavelength range. In the meantime, when a received optical signal has a center wavelength λ and extends in a range of ±Δ, it is regarded that the spectrum of the optical signal has a convex shape wherein a wavelength providing the maximum reception quality matches a wavelength providing the best reception quality. Here, as a modification to the processing of the flowchart in FIG. 8, processing of a flowchart in FIG. 9 will be described.

As will be described below, the processing of the flowchart in FIG. 9 can be regarded as processing of confirming that the wavelength of light to be output by the light source 504 #1 matches the wavelength of light to be output by the light source 504 #2. Further, the processing of the flowchart in FIG. 9 is also processing of controlling to match the wavelength of light to be output by the light source 504 #1 and the wavelength of light to be output by the light source 504 #2, when they do not match but are close to each other.

In Step S901, δ is assigned to a variable “d”. Here, δ is an input parameter for the processing of the flowchart in FIG. 9 to define an increment in which wavelengths are varied. The value of δ may be different from the value of δ used in the processing of the flowchart in FIG. 8. Further, δ may be a negative value as long as it is not zero.

In Step S902, the current oscillation wavelength of the light source 504 #2 is assigned to a variable “p”.

In the processing in Step S903, the value representing the current reception quality is assigned to a variable “q”. When the reception quality is represented by an electric current value output by the amplifiers 509 #2 and 510 #2, the electric current value is obtained and is assigned to the variable “q”. Alternatively, when the reception quality is represented by the value of the error rate of a demodulation by the framer 304 #2, the value of the error rate is obtained and is assigned to the variable “q”.

In Step S904, the sum of the value of the variable “p” and the value of the variable “d” is assigned to the variable “p”.

In Step S905, the oscillation wavelength of the light source 504 #2 is set to the value of the variable “p”.

In Step S906, the value of the variable “q” and the value representing the current reception quality are compared to determine whether or not they substantially equal to each other. Here, the term “the two values substantially equal to each other” means that the absolute value of the difference of the two values is not greater than a given value. An example of the given value may be 1% of the maximum value of electric currents output by the amplifiers 509 #2 and 510 #2. In other words, an oscillation wavelength where the variance of the reception quality is smaller when the oscillation wavelength is varied is identified.

Alternatively, the given value may be set depending on the value of δ. By setting a smaller value to the given value as the value of δ becomes smaller, it is possible to match the wavelengths of light to be output by the light sources 504 #1 and 504 #2 in more precise manner.

When the value of the variable “q” substantially equals the value representing the current reception quality in Step S906, the processing transitions to Step S907 where the oscillation wavelength of the light source 504 #2 is set to the value of (p−d/2). The processing is then terminated. The reason why that value is set and the processing is terminated is that it is presumed that the maximum value of the reception quality is present somewhere between the value of (p−d) and the value of “p” when the value of the variable “q” substantially equals the value representing the current reception quality.

When the value of the variable “q” does not substantially equal the value representing the current reception quality in Step S906, the processing transitions to Step S908.

In Step S908, “q” is compared against the value representing the current reception quality to determine whether the reception quality has been improved (when “q<the current reception quality”) or the reception quality has been reduced (when “q>the current reception quality”), by the change in the oscillation wavelength. In other words, when an electric current value output by the amplifiers 509 #2 and 510 #2 is used as the value representing the reception quality, the reception quality is determined as having improved if the electric current value is increased. Or, when the value of the error rate of a demodulation by the framer 304 #1 is used as the value representing the reception quality, the reception quality is determined as having improved if the error rate is reduced.

When it is determined as “q<the current reception quality” in Step S908, the processing transitions to Step S903. When it is determined as “q<the current reception quality”, the processing transitions to Step S903 since the maximum value of the reception quality will be obtained if the oscillation wavelength is continued to be changed.

Otherwise, when it is determined as “q>the current reception quality” in Step S908, the processing transitions to Step S903. When it is determined as “q>the current reception quality”, the maximum value of the reception quality is considered to be achieved by changing oscillation wavelength by −δ since the reception quality has been reduced with the change of the oscillation wavelength by δ. Hence, “−d” is assigned to “d” in Step S909, and the value of the variable “d” is added to the value of the variable “p” and the sum is assigned to the variable “p” in Step S910. In Step S911, the oscillation wavelength of the light source is set to the value of the variable “p”, and the processing transitions to Step S903.

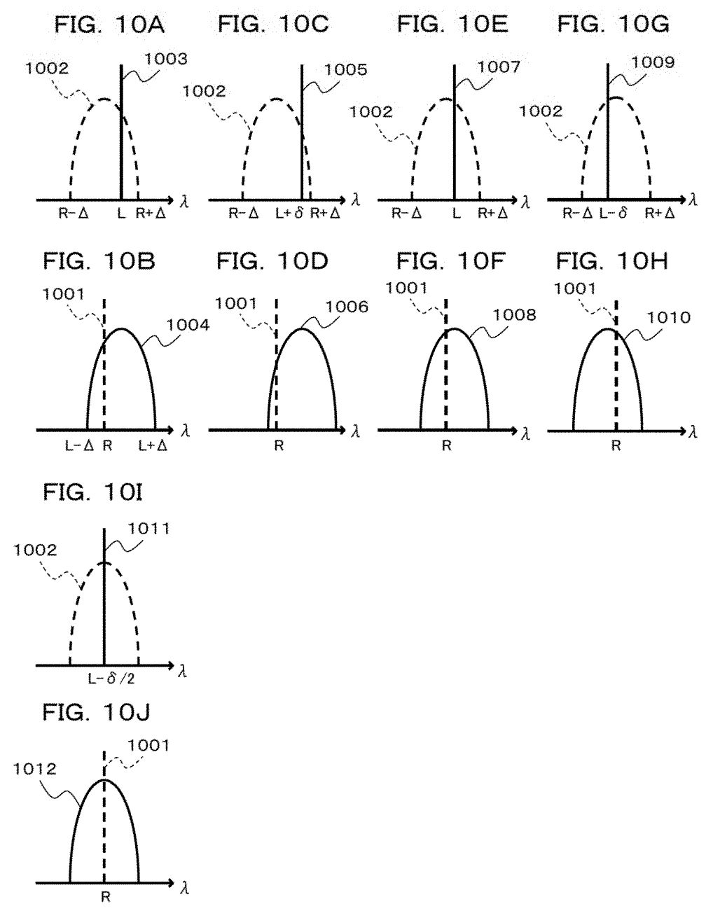

FIGS. 10A-10J are diagrams illustrating examples where the processing depicted in the flowchart in FIG. 9 is executed. FIGS. 10A and 10B are diagrams illustrating the quality before executing the processing depicted in the flowchart in FIG. 9. FIG. 10A is a diagram depicting a spectrum 1002 of an optical signal received by the receiver 502 #2 from the transmitter 501 #1, and a spectrum 1003 of light output by the light source 504 #2. FIG. 10B is a diagram depicting a spectrum 1004 of an optical signal received by the receiver 502 #1 from the transmitter 501 #2, and a spectrum 1001 of light output by the light source 504 #1.

As depicted in the wavelength axis in FIG. 10A, the optical signal received by the receiver 502 #2 from the transmitter 501 #1 has a central wavelength of R and a divergence of ±Δ, and the wavelength L of the light output by the light source 504 #2 is greater than R. Similarly, as depicted in the wavelength axis in FIG. 10B, the optical signal received by the receiver 502 #1 from the transmitter 501 #2 has a central wavelength of L and a divergence of ±Δ. While the optical signal 1002 and the optical signal 1004 have the same divergence for the sake of the simplicity of the descriptions, they may be different.

In the situations of FIGS. 10A and 10B, after Steps S901 to S903 are executed, the value of the variable “p” is set to L, and the value representing the current reception quality in the receiver 502 #2 is assigned to the variable “q”. For example, the length from the wavelength axis in FIG. 10A to the point where the line segment of the spectrum 1003 intersects the spectrum 1002 is assigned to the variable “q”.

Next, after Steps S904 and S905 are executed, as depicted in FIGS. 10C and 10D, the oscillation wavelength of the light source 504 #2 in the transmitter 501 #2 is (L+δ), and an optical signal received by the receiver 502 #2 has a spectrum 1006. After Step S906 is executed in this quality, the value representing the current reception quality becomes the value corresponding to the length from the wavelength axis in FIG. 10C to the point where the line segment of the spectrum 1005 intersects the spectrum 1002. If the value of the variable “q” does not substantially equal the value representing the current reception quality in Step S906, the processing will transition to Step S908. In this step, the condition “q>the current reception quality” holds true, and it is assumed that the value of the variable “q” does not substantially equal the value representing the current reception quality.

Since the condition “q>the current reception quality” holds true in Step S908, the processing transitions to Step S909 where “−d” is assigned to “d”. In Step S909, L is assigned to the variable “p”, and the oscillation wavelength of the light source 504 #2 becomes L in Step S911. In other words, as depicted in FIGS. 10E and 10F, light output by the light source 504 #2 has a spectrum 1007 and an optical signal received by the receiver 502 #1 has a spectrum 1008.

After Step S903 is executed in the quality in FIGS. 10E and 10F, the length from the wavelength axis to the point where the half-line 1007 intersects the waveform 1002 is assigned to the variable “q”.

Next, after Steps S904 and S905 are executed, the wavelength of light output by the light source 504 #2 becomes (L−δ). As a result, light output by the light source 504 #2 has a spectrum. 1009 as depicted in FIG. 10G, and an optical signal received by the receiver 502 #1 has a spectrum 1010 as depicted in FIG. 10H. After Step S906 is executed in this quality, the value representing the current reception quality becomes the length from the wavelength axis of FIG. 10G to the point where the line segment of the spectrum 1009 intersects the spectrum 1002. When it is assumed that the value of the variable “q” substantially equals the value representing the current reception quality in Step S906, the processing transitions to Step S907.

In Step S907, the oscillation wavelength of the light source 504 #2 is set to (p−d/2). In this time, since (L−δ) has been assigned to the variable “p” and −δ has been assigned to “d”, the wavelength of light output by the light source 504 #2 is set to (L−δ/2) due to the execution of the processing in Step S907. Referring to FIGS. 10I and 10J, light output by the light source 504 #2 has a spectrum 1011 and light received by the receiver 502 #1 has a spectrum 1012.

Referring to FIGS. 10I and 10J, (L−δ/2) substantially equals R. Further, referring to FIGS. 10I and 10J, the spectrum 1002 of the optical signal received by the receiver 502 #2 substantially equals the spectrum 1012 received by the receiver 502 #1.

As set forth above, it is possible to match the oscillation wavelength of the light source 504 #1 in the transmitter 501 #1 and the oscillation wavelength of the light source 504 #2 in the transmitter 501 #2 by controlling the oscillation wavelength of the light source 504 #2 in the transmitter 501 #2.

Since the increment of the oscillation wavelength of δ is used in the flowchart in FIG. 9, the oscillation wavelength of the light source 504 #2 set in Step S907 may have a deviation of ±δ at maximum from the ideal oscillation wavelength. Here, the term the “ideal oscillation wavelength” is the oscillation wavelength of the light source 504 #1 in the transmitter 501 #1.

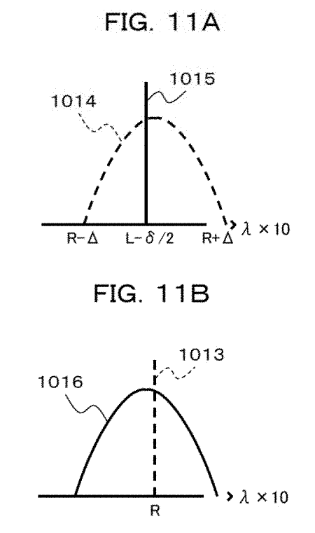

Therefore, as depicted in FIGS. 11A and 11B, it is possible to carry out the processing in FIG. 9 again after the precision of the wavelength axis is increased ten-hold, for example. Increasing the precision of the wavelength axis ten-holds is equivalent to executing the flowchart depicted in FIG. 9 after reducing δ to one-tenth of its original value. As depicted in FIG. 11A, when the precision of the wavelength axis is increased, the deviation between the center of the spectrum 1014 of the optical signal received by the receiver 502 #2 from the transmitter 501 #1 and the spectrum 1015 of the light output by the light source 504 #2 can be seen more evidently. Similarly, as depicted in FIG. 11B, the deviation between the center of the spectrum 1016 of the optical signal received by the receiver 502 #1 from the transmitter 501 #2 and the spectrum 1013 of the light output by the light source 504 #1 can also be seen more evidently. When δ is changed to one-tenth of its original value, for example, the given value used in Step S906 for determining whether or not “q” substantially equals the value representing the current reception quality is also modified accordingly.

As set forth above, unlike the processing of the flowchart depicted in FIG. 8, in the present embodiment, the entirety of the selected adjustable wavelength range is not scanned from its lower limit to the upper limit and a further efficient control of the oscillation wavelength can be achieved.

(Modifications)

Hereinafter, modifications of the embodiments described above will be described.

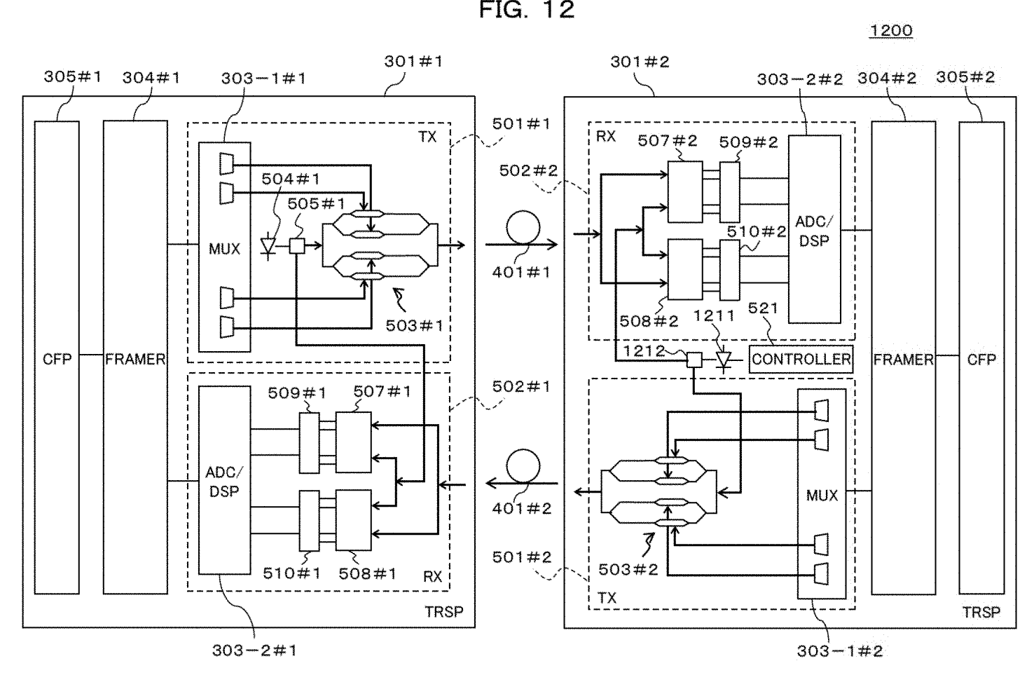

FIG. 12 is a functional block diagram of an optical transmission system including a TRSP 301 #2 in accordance with a first modification. It differs from the functional block diagram depicted in FIG. 5 in that the light source 504 #2 in the transmitter 501 #2 depicted in FIG. 5 is not placed within the transmitter 501 #2, but that a light source 1211 is disposed outside the transmitter 501 #2 and the receiver 502 #2.

Once light output by the light source 1211 is input into an optical branch unit 1212, the light is branched to the transmitter 501 #2 and the receiver 502 #2. In this configuration, the length of the waveguide from the optical branch unit 1212 to the modulator 503 #2 can be matched with the length of the waveguide from the optical branch unit 1212 to the 90-degree optical hybrid circuits 507 #2 and 508 #2, for example, and hence it is possible to match the light losses through the light guides. As a result, the light branching ratio by the optical branch unit 1212 can be precisely set, for example.

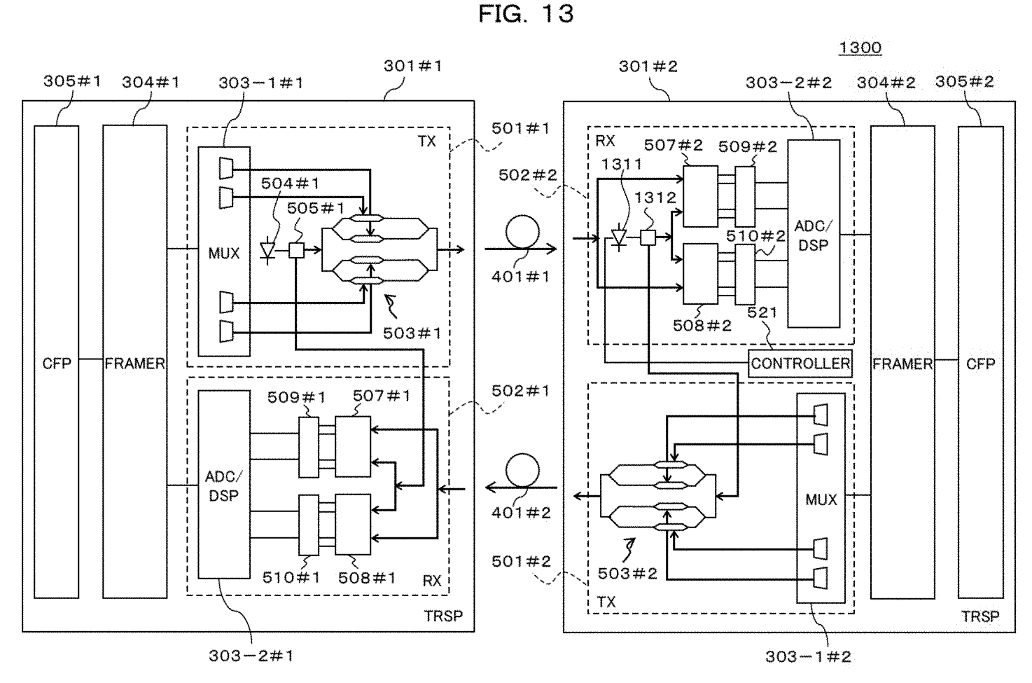

FIG. 13 is a functional block diagram of an optical transmission system including a TRSP 301 #2 in accordance with a second modification. It differs from the functional block diagram depicted in FIG. 5 in that the light source 504 #2 in the transmitter 501 #2 depicted in FIG. 5 is not placed within the transmitter 501 #2, but that a light source 1311 is placed in the receiver 502 #2.

Once light output by the light source 1311 is input into an optical branch unit 1312, the light is branched into light toward the 90-degree optical hybrid circuits 507 #2 and 508 #2 and light toward the transmitter 501 #2.

The light source 504 #2 and the light source 1311 generate heat, and the quantity of generated heat may be varied under the control of the controller 521. In this case, a deviation in the quantity of the heat generated by the light source 504 #2 may affect the modulation property of the modulator 503 #2. Therefore, the modulation property of the modulator 503 #2 can be stabilized by placing the light source 1311 within the receiver 502 #2.

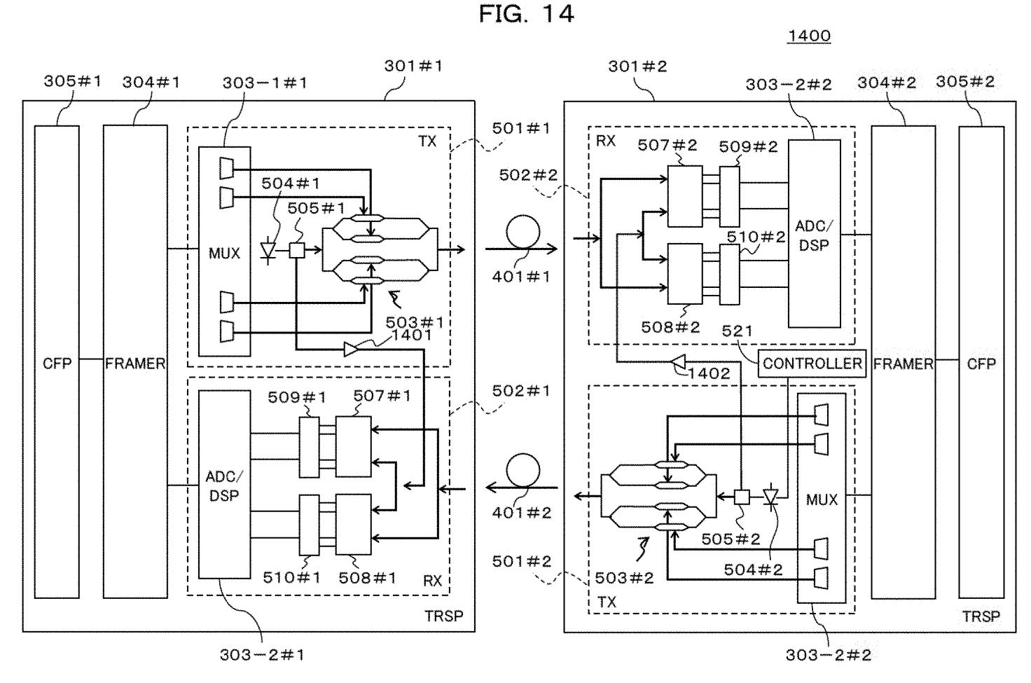

FIG. 14 is a functional block diagram of an optical transmission system 1400 including a TRSP 301 #2 in accordance with a third modification. It differs from the functional block diagram depicted in FIG. 5 in that an amplifier 1401 is disposed en route of the waveguide extending from the optical branch unit 505 #1 to the receiver 502 #1 in FIG. 14. Another difference from the functional block diagram depicted in FIG. 5 is in that an amplifier 1402 is disposed en route of the light guide extending from the optical branch unit 505 #2 to the receiver 502 #1 in FIG. 14. By disposing the amplifiers 1401 and 1402, any light losses through the waveguides toward the receiver 502 #1 and the receiver 502 #2 can be compensated, and hence the receiver sensitivities can be improved.

As depicted in FIGS. 12-14, the location of the light source 504 #1 in the TRSP 301 #1 is not always equivalent to the location of the light source 504 #2 in the TRSP 301 #2. A TRSP in accordance with a comparative example, which will be described later, can be used as the TRSP 301 #1. Even when the TRSP according to the comparative example, which will be described later, is used as the TRSP 301 #1, the TRSP 301 #2 transmits an optical signal with a carrier wave wavelength having the same wavelength as that of the carrier wave wavelength of a received optical signal. Thus, an adjustment of the oscillation wavelength of the light source in the TRSP #1 can be simplified, as compared to that of the comparative example.

In accordance with the embodiments and the modifications described above, a TRSP as one example of a transmission apparatus includes a light transceiver 302 (e.g., FIG. 3). Here, the light transceiver 302 includes a light source 504 #2 (e.g., FIG. 5) or 1212 (e.g., FIG. 12), a transmitter 501 #2 (e.g., FIG. 5 or 12), a receiver 502 #2 (e.g., FIG. 5 or 12), and a controller 521 (e.g., FIG. 5 or 12). The transmitter 501 #2 is configured to transmit a first optical signal, the first optical signal being generated by modulating first light output by the light source 1212. The receiver 502 #2 is configured to coherently receive a second optical signal using the first light output by the light source 1212. The controller 521 is configured to control the wavelength of the first light based on a result of the reception of the second optical signal by the receiver 502 #2. The light transceiver 302 may also be referred to as the “optical transceiver” or the “optical transmission and reception module”.

Further, a second TRSP that carries out transmissions and receptions with the above-described TRSP as one example of a transmission apparatus includes a second light transceiver 302 (e.g., FIG. 3). Here, the second light transceiver 302 includes a second light source 504 #1 (e.g., FIG. 5), a second transmitter 501 #1 (e.g., FIG. 5), and a second receiver 502 #1 (e.g., FIG. 5). The second transmitter 501 #1 is configured to transmit the second optical signal, the second optical signal being generated by modulating second light output by the second light source 504 #1. The second receiver 502 #1 is configured to coherently receive the first optical signal using the second light output by the second light source 504 #1. The second light transceiver 302 may also be referred to as the “second light transceiver” or the “second light transmission and reception module”.

### Comparative Example

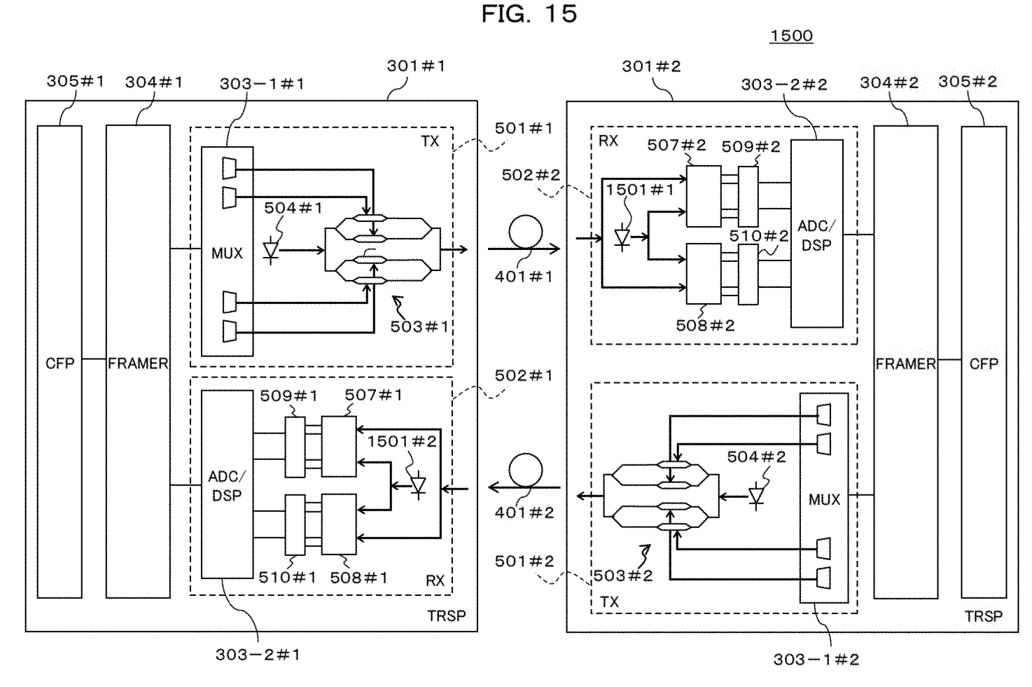

Finally, an optical transmission system in accordance with a comparative example will be described. FIG. 15 is a functional block diagram of an optical transmission system according to the comparative example.

FIG. 15 is different from FIGS. 5, 12, 13, and 14 in that light sources 1501 #2 and 1501 #2 are provided in FIG. 15, in addition to light sources 504 #1 and 504 #2. The light source 1501 #2 and 1501 #2 function as local oscillation light sources of receivers 502 #1 and 502 #2, respectively.

Therefore, in the optical transmission systems in accordance with the embodiments described above, the number of light sources can be reduced as compared to that of the optical transmission system in accordance with the comparative example. Hence, a reduction in the costs, reductions in the device sizes due to the reduction in light sources, and reduced power consumption can be achieved.

Furthermore, operations to adjust the oscillation wavelengths are complicated in the optical transmission system in accordance with the comparative example. Specifically, an operation to match the oscillation wave lengths of the light source 504 #1 in the transmitter 501 #1 and the light source 1501 #2 in the receiver 502 #2, and another operation to match the oscillation wavelengths of the light source 504 #1 in the transmitter 501 #1 and the light source 1501 #2 in the receiver 502 #1 are needed. Since the TRSP 301 #1 and the TRSP 301 #2 are usually installed in locations that are distant apart from each other, the adjustments of the oscillation wavelengths will be further annoying.

In contrast, the optical transmission systems in accordance with the embodiments described above, since it is suffice to adjust only the oscillation wavelength of a single light source, the adjustment can be done in shorter time and more easily as compared to conventional techniques.

In one aspect, in an optical transmission system that transmits coherent light between transmission apparatuses, the number of light sources provided in transmission apparatuses is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission system comprising:
a first transmission apparatus; and
a second transmission apparatus connected to the first transmission apparatus so as to be optically communicative to each other,
the first transmission apparatus comprising:
a first light source;
a first transmitter configured to transmit a first optical signal to the second transmission apparatus, the first optical signal being generated by modulating first light output by the first light source; and
a first receiver configured to coherently receive a second optical signal transmitted by the second transmission apparatus, using the first light output by the first light source, and
the second transmission apparatus comprising:
a second light source;
a second transmitter configured to transmit the second optical signal to the first transmission apparatus, the second optical signal being generated by modulating second light output by the second light source;
a second receiver configured to coherently receive the first optical signal received by the first transmission apparatus, using the second light output by the second light source; and
a controller configured to control a wavelength of the second light to be output by the second light source, based on a result of the reception of the first optical signal by the second receiver.

2. The optical transmission system according to claim 1, wherein a wavelength of the light generated by the first light source is fixed.

3. The optical transmission system according to claim 1, wherein the controller is configured to control the wavelength of the second light to be output by the second light source toward a direction to increase a reception quality of the first optical signal at the second receiver.

4. The optical transmission system according to claim 1, wherein the controller is configured to record the reception quality of the first optical signal at the second receiver while varying the wavelength of the second light to be output by the second light source, and control the wavelength of the light to be generated by the second light source to a light wavelength where a highest reception quality is recorded.

5. The optical transmission system according to claim 1, wherein the controller is configured to:
increase the wavelength of the light to be generated by the second light source while the reception quality of the first optical signal at the second receiver is increased, by increasing the wavelength of the light to be output by the second light source; and
reduce the wavelength of the light to be generated by the second light source while the reception quality of the first optical signal at the second receiver is increased, by reducing the wavelength of the light to be generated by the second light source.

6. The optical transmission system according to claim 1, wherein
the second transmission apparatus further comprises an amplifier configured to amplify the second light output by the second light source, and
the second receiver is configured to coherently receive the second optical signal using the second light amplified by the amplifier.

7. A transmission apparatus comprising:
a light source;
a transmitter configured to transmit a first optical signal, the first optical signal being generated by modulating first light output by the light source;
a receiver configured to coherently receive a received second optical signal, using the first light output by the light source; and
a controller configured to control a wavelength of the first light, based on a result of the reception of the second optical signal by the receiver.

8. The transmission apparatus according to claim 7, wherein the controller is configured to change the wavelength of the light to be generated by the first light source toward a direction to increase a reception quality of the second optical signal at the receiver.

9. The transmission apparatus according to claim 7, wherein the controller is configured to record the reception quality of the second optical signal at the receiver while varying the wavelength of the light to be generated by the light source, and control the wavelength of the light to be generated by the first light source to a light wavelength where a highest reception quality is recorded.

10. The transmission apparatus according to claim 7, wherein the controller is configured to:
increase the wavelength of the light to be generated by the light source while the reception quality of the second optical signal at the receiver is increased, by increasing the wavelength of the light to be generated by the light source; and
reduce the wavelength of the light to be generated by the light source while the reception quality of the second optical signal at the receiver is increased, by reducing the wavelength of the light to be generated by the light source.

11. The transmission apparatus according to claim 7, further comprising an amplifier configured to amplify the first light output by the light source,
wherein the receiver is configured to coherently receive the first optical signal, using the first light amplified by the amplifier.

12. A method of controlling a wavelength in an optical transmission system comprising a first transmission apparatus, and a second transmission apparatus connected to the first transmission apparatus so as to be optically communicative to each other, the method comprising:
in the first transmission apparatus,
transmitting a first optical signal to the second transmission apparatus, the first optical signal being generated by modulating first light generated by a first light source; and
coherently receiving a second optical signal from the second transmission apparatus, using the first light generated by the first light source,
in the second transmission apparatus,
transmitting the second light signal to the first transmission apparatus, the second light signal being generated by modulating second light generated by a second light source;
coherently receiving the first optical signal transmitted by the first transmission apparatus, using the second light output by the second light source; and
controlling a wavelength of the light to be generated by the second light source, based on a result of the reception of the first optical signal.

13. The method according to claim 12, further comprising fixing a wavelength of the light generated by the first light source.

14. The method according to claim 12, further comprising
controlling the wavelength of the light to be output by the second light source toward a direction to increase a reception quality of the first optical signal.

15. The method according to claim 12, further comprising
recording the reception quality of the first optical signal while varying the wavelength of the light to be output by the second light source, and changing a wavelength of light to be generated by the second light source to a light wavelength where a highest reception quality is recorded.

16. The method according to claim 13, further comprising
increasing a wavelength of light to be generated by the second light source while a detected reception quality of the first optical signal is increased, by increasing the wavelength of the light to be generated by the second light source; and
reducing a wavelength of light to be generated by the second light source while the reception quality of the first optical signal is increased, by reducing the wavelength of the light to be generated by the second light source.

17. The method according to claim 13, further comprising
amplifying the second light, and coherently receiving the first optical signal.
